(19) United States
(12) Patent Application Publication
(10) Pub. No.: US 2024/0410473 A1
(43) Pub. Date: Dec. 12, 2024

(54) Linear Displacement Valve

(71) Applicant: WAL Fuel Systems USA Inc., Livonia, MI (US)

(72) Inventors: Xiaoqin Zhang, Livonia, MI (US); Xiankai Song, Livonia, MI (US)

(21) Appl. No.: 18/331,684

(22) Filed: Jun. 8, 2023

(51) Int. Cl. F16K 5/02

(52) U.S. Cl. CPC F16K 5/0207

(57) ABSTRACT

A linear displacement valve for a vehicle includes a body defining an inlet corridor and an outlet corridor and a seat disposed within the body between the inlet corridor and the outlet corridor. The seat defines an opening configured to fluidly couple the inlet corridor with the outlet corridor. The linear displacement valve further includes a plug movable relative to the seat. The plug includes a perimeter surface configured to abut and seal against the seat to close the opening and a flow guide surface having a first portion and a second portion. The first portion of the flow guide surface is disposed between the second portion of the flow guide surface and the perimeter surface. The first portion has a concave curvature, and the second portion has a convex curvature.

### TECHNICAL FIELD

This disclosure relates generally to the field of linear displacement valves for a vehicle.

### BACKGROUND

Many industries utilize throttle valves to regulate the flow of a fluid. One particular application is a fuel cell, which is an electrochemical device that combines hydrogen fuel with oxygen to produce electricity. The flow of the gaseous and/or liquid fluids must be regulated to ensure a chemical reaction occurs that produces the electricity. As such, the ability to the fluid flow is desirable.

### SUMMARY

One aspect of the disclosure is a linear displacement valve for a vehicle that includes a body defining an inlet corridor and an outlet corridor and a seat disposed within the body between the inlet corridor and the outlet corridor. The seat defines an opening configured to fluidly couple the inlet corridor with the outlet corridor. The linear displacement valve further includes a plug movable relative to the seat. The plug includes a perimeter surface configured to abut and seal against the seat to close the opening and a flow guide surface having a first portion and a second portion. The first portion of the flow guide surface is disposed between the second portion of the flow guide surface and the perimeter surface. The first portion has a concave curvature, and the second portion has a convex curvature.

In some implementations of the linear displacement valve, the perimeter surface and the seat have annular configurations that correspond to one another.

In some implementations of the linear displacement valve, the plug includes a node spaced from and surrounded by the perimeter surface. The flow guide surface is arranged to extend radially from the node to the perimeter surface.

In some implementations of the linear displacement valve, the second portion of the flow guide surface is configured to converge at the node and defines an apex of the plug.

In some implementations of the linear displacement valve, the perimeter surface has an annular configuration. The node is centrally aligned within the perimeter surface.

In some implementations of the linear displacement valve, the perimeter surface of the plug has a width between opposing portions of the perimeter surface and has a height to the node, orthogonal to the width. The plug has a width-to-height ratio of about 4/1 to about 2/1.

In some implementations of the linear displacement valve, the linear displacement valve further includes a fin extending from the flow guide surface in a helical configuration between the perimeter surface and the node.

In some implementations of the linear displacement valve, the perimeter surface is disposed on a plane. The seat extends transverse to the plane.

In some implementations of the linear displacement valve, the plug is movable along an axis that is orthogonal to the plane.

In some implementations of the linear displacement valve, the linear displacement valve further includes a stem mounted to the plug and a guide coupled to the body and the defining a bore. The stem is slidably disposed within the bore such that the guide is configured to retain movement of the stem and the plug along the axis.

In some implementations of the linear displacement valve, the body includes an outlet surface extending from the seat and at least partially defining the outlet corridor. The outlet surface extends in a direction generally parallel to the axis.

Another aspect of the disclosure is a plug for use with a linear displacement valve. The plug includes a perimeter surface configured to abut and seal against a seat to close an opening, and a flow guide surface having a first portion and a second portion. The first portion of the flow guide surface is disposed between the second portion of the flow guide surface and the perimeter surface. The first portion has a concave curvature and the second portion has a convex curvature.

In some implementations of the plug, the plug further includes a node spaced from and surrounded by the perimeter surface. The flow guide surface is arranged to extend radially from the node to the perimeter surface.

In some implementations of the plug, the second portion of the flow guide surface is configured to converge at the node and defines an apex of the plug.

In some implementations of the plug, the perimeter surface has an annular configuration. The node is centrally aligned within the perimeter surface.

In some implementations of the plug, the perimeter surface of the plug has a width between opposing portions of the perimeter surface and has a height to the node, orthogonal to the width. The plug has a width-to-height ratio of about 4/1 to about 2/1.

In some implementations of the plug, the plug further includes a fin extending from the flow guide surface in a helical configuration between the perimeter surface and the node.

In some implementations of the plug, the perimeter surface is disposed on a plane. The fin extends outwardly from the flow guide surface in a direction generally parallel to the plane.

In some implementations of the plug, the flow guide surface further includes a transition portion disposed between the first portion and the perimeter surface, with the transition portion having a convex curvature.

Another aspect of the disclosure is a linear displacement valve for a vehicle. The linear displacement valve includes a body defining an inlet corridor and an outlet corridor and a seat disposed within the body between the inlet corridor and the outlet corridor. The seat defines an opening configured to fluidly couple the inlet corridor with the outlet corridor. The linear displacement valve includes a plug movable relative to the seat. The plug includes a perimeter surface configured to abut and seal against the seat to close the opening, a node spaced from and surrounded by the perimeter surface, and a flow guide surface having an arcuate configuration between the perimeter surface and the node. The plug further includes a fin disposed along the flow guide surface and extending in a helical configuration between the perimeter surface and the node.

In some implementations of the linear displacement valve, the perimeter surface is disposed on a plane. The fin extends outwardly from the flow guide surface in a direction generally parallel to the plane.

### BRIEF DESCRIPTION OF THE DRAWINGS

FIG. 1 is a perspective view illustration of a linear displacement valve.

FIG. 2 is a cross-sectional view illustration of an example implementation of the linear displacement valve, showing a plug in an open position.

FIG. 3 is a cross-sectional view illustration of the linear displacement valve of FIG. 2, showing the plug in a closed position.

FIG. 4 is a perspective view illustration of the plug of FIG. 2.

FIG. 5 is a schematic side view illustration of the linear displacement valve of FIG. 2, showing flow of a fluid through the linear displacement valve.

FIG. 6 is a cross-sectional view illustration of an example implementation of the linear displacement valve, showing the plug having a fin and disposed in the open position.

FIG. 7 is a cross-sectional view illustration of the linear displacement valve of FIG. 6, showing the plug in the closed position.

FIG. 8 is a perspective view illustration of the plug of FIG. 6.

FIG. 9 is a schematic side view illustration of the linear displacement valve of FIG. 6, showing the flow of the fluid through the linear displacement valve.

### DETAILED DESCRIPTION

This disclosure is directed to linear displacement valves for use in a vehicle. One particular application of a linear displacement valve in a vehicle is a fuel cell, which is an electrochemical device that combines hydrogen fuel with oxygen to produce electricity that powers (among other things) electric motors which propel the vehicle. The flow of the hydrogen and the oxygen must be regulated to ensure a complete chemical reaction occurs that produces the electricity.

Traditional linear displacement valves utilize a body having an inlet passage and an outlet passage and plug that selectively seals an opening between the inlet passage and the outlet passage. The plug has a perimeter surface that seals the opening and a planar surface that extends between the perimeter surface. When the plug is spaced from the opening, a fluid flows from the inlet passage toward the opening. The planar surface causes strong secondary flows (i.e., flow separation, recirculation, stagnation, vortices, etc.), which causes a pressure loss and reduced fluid flow through the opening. More specifically, plug forms asymmetries in the flow-cross-sectional area through the opening. The portion of the opening that is furthest from the inlet passage experiences a high-pressure zone, which causes a portion of the fluid to flow along the planar surface back towards the inlet passage. In-turn, a low-pressure zone (with strong recirculation and stagnation) develops within the outlet passage, which reduces the flow-cross-sectional area within the outlet passage and correspondingly reduces the flow of the fluid through the outlet passage.

The linear displacement valve described herein includes a flow guide surface on the plug that diverts the flow of fluid that traverses across the plug. The flow guide surface allows for surface-bounded flow of the fluid into the outlet passage, which reduces pressure drop across the plug and improves the flow of the fluid through the linear displacement valve.

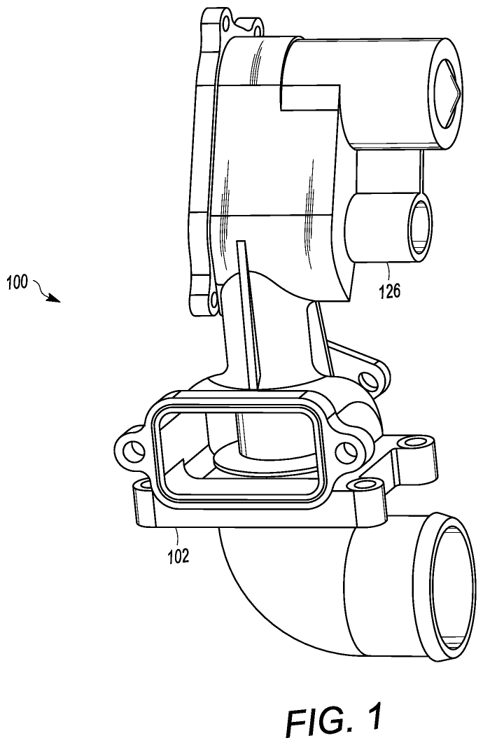

FIG. 1 is a perspective view illustration of a linear displacement valve 100 for a vehicle. The vehicle may be a road-going vehicle that is supported by wheels and is able to travel freely upon roadways and other surfaces. The linear displacement valve 100 is used to regulate the flow of a fluid. In one example, the linear displacement valve 100 is utilized in hydrogen fuel cell system to regulate the flow of hydrogen and/or oxygen. However, the linear displacement valve 100 may be utilized in other systems to regulate the flow of a fluid, such as in a coolant system.

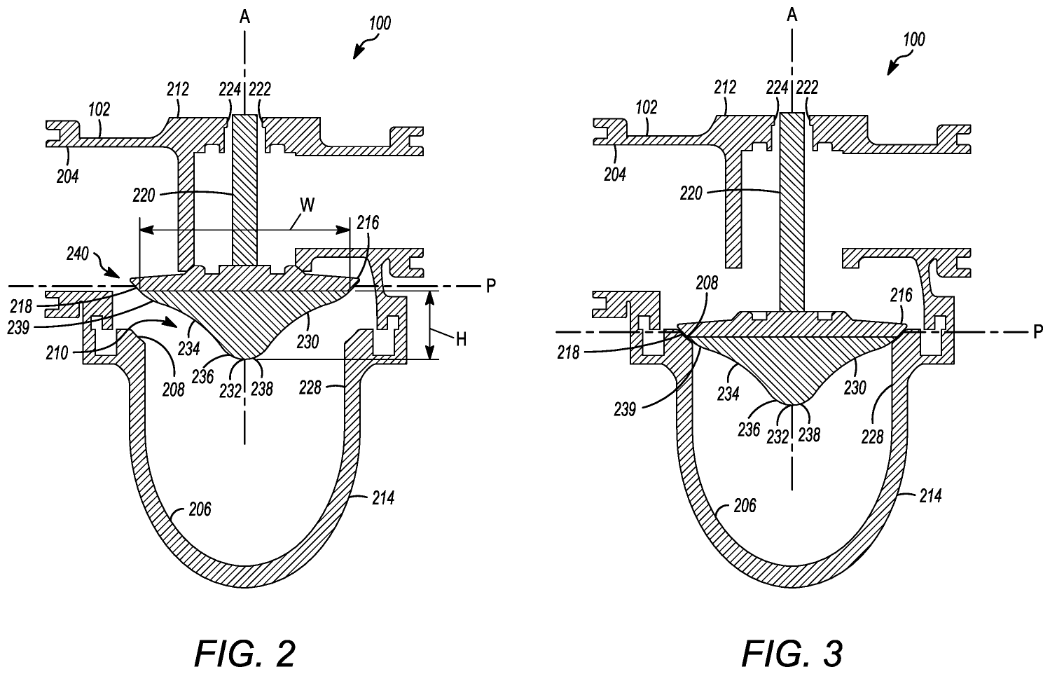

The linear displacement valve 100 includes a body 102. FIGS. 2 and 3 are cross-sectional view illustrations of an example of the linear displacement valve 100, showing the body 102 defining an inlet corridor 204 and an outlet corridor 206 and a seat 208 disposed within the body 102 between the inlet corridor 204 and the outlet corridor 206. The seat 208 defines an opening 210 configured to fluidly couple the inlet corridor 204 with the outlet corridor 206. The body 102 comprises a first section 212 including the inlet corridor 204 and a second section 214 including the outlet corridor 206. The first section 212 and the second section 214 may separate components that are joined to one another when assembled to form the body 102. Alternatively, the body 102 may be comprised of a unitary component or any suitable number of components. In the example shown in FIGS. 2 and 3, the seat 208 is formed by the body 102 (more specifically, the second section 214 of the body 102). However, the seat 208 may be an independent component that is mounted to the body 102.

In the example shown in FIGS. 2 and 3, the inlet corridor 204 and the outlet corridor 206 have generally orthogonal orientations. More specifically, the inlet corridor 204 is shown as being disposed generally horizontal and the outlet corridor 206 is shown as being disposed generally vertical. The inlet corridor 204 bends adjacent the seat 208 to position the inlet corridor 204 and the outlet corridor 206 in alignment through the opening 210 defined by the seat 208. It is to be appreciated that the inlet corridor 204 and the outlet corridor 206 may be positioned in any suitable configuration to allow the inlet corridor 204 and the outlet corridor 206 to be fluidly coupled with one another.

The linear displacement valve 100 further includes a plug 216 movable relative to the seat 208 between an open position (shown in FIG. 2) and a closed position (shown in FIG. 3). More specifically, the plug 216 includes a perimeter surface 218 configured to abut and seal against the seat 208 to close the opening 210 in the closed position. The perimeter surface 218 of the plug 216 is spaced from the seat 208 to allow the fluid to move through the opening 210 between the inlet corridor 204 and the outlet corridor 206 in the open position.

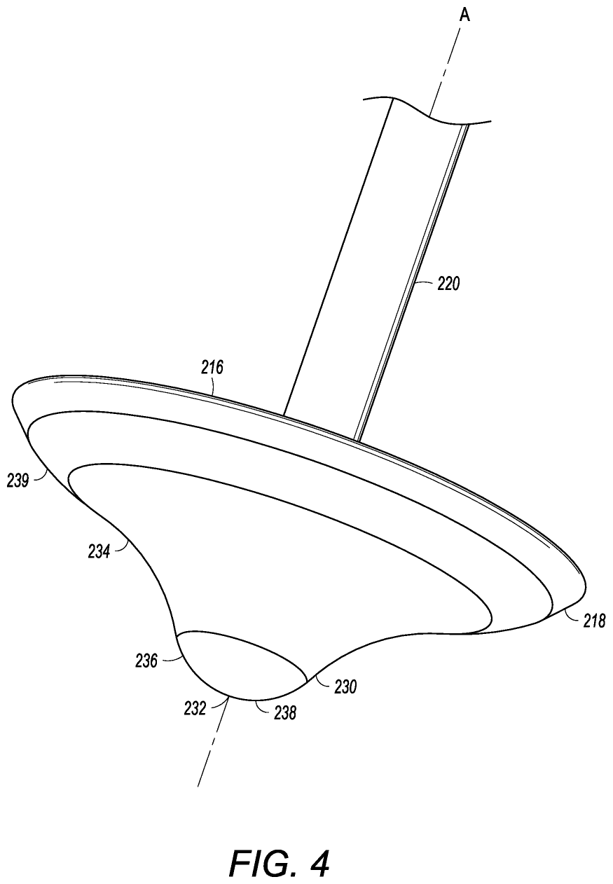

The perimeter surface 218 and the seat 208 are sized and shaped such that the perimeter surface 218 engages the entirety of the seat 208 to close the opening 210. FIG. 4 is a perspective view illustration of the plug 216, showing that the plug 216 has an annular configuration. More specifically, the perimeter surface 218 and the seat 208 have annular configurations that correspond to one another. However, the perimeter surface 218 and the seat 208 may have any suitable corresponding configurations, including configurations that are asymmetric.

In the example shown in FIGS. 2 and 3, the perimeter surface 218 is disposed on a plane P. The plug 216 is movable along an axis A that is orthogonal to the plane P. More specifically, the plug 216 extends radially outward from the axis A to the perimeter surface 218 on the plane P. Likewise, the seat 208 is disposed on the plane P when the plug 216 is in the closed position. The plug 216 translates on the axis A in a linear path between the open position and the closed position. More specifically, the plug 216 moves away from the seat 208 and into the inlet corridor 204 when the plug 216 moves from the closed position to the open position. It is to be appreciated that the axis A may extend in any suitable orientation relative to the plane P, with the plug 216 configured to move along the axis A in any suitable manner. Moreover, in other examples the plug 216 may pivot, rotate, or otherwise move along the axis A or away from the axis A to facilitate movement of the plug 216 between the open position and the closed position.

In the example shown in FIGS. 2 and 3, the seat 208 extends transverse to the plane P. More specifically, the seat 208 extends between the inlet corridor 204 and the outlet corridor 206 in a direction that is transverse to the plane P. As such, the seat 208 is tapered between the inlet corridor 204 and the outlet corridor 206. More specifically, the seat 208 tapers inwardly toward the axis A from the inlet corridor 204 to the outlet corridor 206. This taper of the seat 208 causes the seat 208 to extend in-part along the axis A (referred to as a y-component of the taper) and in-part lateral to axis A (referred to as an x-component of the taper). The x-component of the taper of the seat 208 ensures that the plug 216 contacts and seals against the seat 208 in the closed position while the y-component of the taper of the seat 208 allows the flow of the fluid along the seat 208 from the inlet corridor 204 to the outlet corridor 206 when the plug 216 is in the open position. It is to be appreciated that in other examples, the seat 208 may extend in other orientations relative to the plane P and/or the axis A. Moreover, in other examples the orientation of the seat 208 may vary at different locations along the seat 208.

The linear displacement valve 100 further includes a stem 220 mounted to the plug 216 and a guide 222 coupled to the body 102 and defining a bore 224. The stem 220 is slidably disposed within the bore 224 such that the guide 222 is configured to retain movement of the stem 220 and the plug 216 along the axis A. The stem 220 extends linearly from the plug 216 along the axis A. The stem 220 extends through the inlet corridor 204 and into the body 102 (more specifically, the first section 212 of the body 102 in the example shown in FIGS. 2 and 3). The guide 222 is disposed within the body 102, with the bore 224 extending therethrough and along the axis A. In this example, the guide 222 is a unitary component of the body 102.

However, the guide 222 may be a separate component that is mounted to the body 102. The bore 224 is configured to have a size and shape similar to the stem 220 to receive the stem 220 therein and allow movement of the stem 220 along the axis A, while inhibiting movement of the stem 220 lateral to the axis A.

As shown in FIG. 1, the linear displacement valve 100 further includes an actuator 126 coupled to the body 102. The actuator 126 is configured to move the stem 220 along the axis A and correspondingly move the plug 216 between the open position and the closed position. The actuator 126 may comprise an electric linear actuator that utilizes electric current to produce mechanical motion. The electric linear actuator may receive the electric current as dictated by a controller, mechanical switch, etc. It is to be appreciated that the actuator 126 may be configured as hydraulic actuator, pneumatic actuator, or any other suitable configuration that may move the stem 220 and the plug 216.

As shown in FIGS. 2 and 3, the body 102 includes an outlet surface 228 extending from the seat 208 and at least partially defining the outlet corridor 206. The outlet surface 228 extends in a direction generally parallel to the axis A. More specifically, in the example shown in FIGS. 2 and 3 with the seat 208 having the annular configuration, the outlet surface 228 extends from the seat 208 in a generally cylindrical configuration about the axis A. the outlet surface 228 extending from the seat 208 in the direction generally parallel to the axis A allows laminar flow of the fluid within the outlet corridor 206 after the fluid passes by the seat 208.

As shown in FIGS. 2-4, the plug 216 includes a flow guide surface 230. The flow guide surface 230 is disposed opposite the stem 220, with the flow guide surface 230 facing the outlet corridor 206 of the body 102. The plug 216 further includes a node 232 spaced from and surrounded by the perimeter surface 218. The flow guide surface 230 is arranged to extend radially from the node 232 to the perimeter surface 218. The node 232 is spaced from the plane P such that the flow guide surface 230 projects outwardly from the perimeter surface 218 toward the node 232. More specifically, with the plug 216 disposed in the closed position, the flow guide surface 230 projects into the outlet corridor 206. The flow guide surface 230 extending outwardly from the perimeter surface 218 toward the node 232 reduces flow resistance past the plug 216 and through the opening 210 in comparison to a plug 216 having a planar surface that extends between the perimeter surface 218. The fluid flow characteristics of the flow guide surface 230 will be described in greater detail below.

The perimeter surface 218 of the plug 216 has a width W between opposing portions of the perimeter surface 218 and has a height H to the node 232, orthogonal to the width W. In one example, the plug 216 has a width-to-height ratio of about 4/1 to about 2/1. In another example, the plug 216 has a width-to-height ratio of about 3.5/1 to about 2.5/1. It is to be appreciated that the plug 216 may have any suitable height H and any suitable width W to produce a desire flow characteristic of the fluid across the flow guide surface 230.

The flow guide surface 230 has a first portion 234 and a second portion 236. The first portion 234 of the flow guide surface 230 is disposed between the second portion 236 of the flow guide surface 230 and the perimeter surface 218. The second portion 236 of the flow guide surface 230 is configured to converge at the node 232. In the example shown in FIGS. 2 and 3, the node 232 is centrally aligned within the perimeter surface 218, which has the annular configuration. Moreover, the node 232 is disposed along the axis A. It is to be appreciated that the node 232 may be offset relative to the perimeter surface 218 (i.e., not centrally aligned within the perimeter surface 218).

The flow guide surface 230 has an arcuate configuration between the perimeter surface 218 and the node 232. In the example shown in FIGS. 2 and 3, the first portion 234 has a concave curvature, and the second portion 236 has a convex curvature. The convergence of the second portion 236 of the flow guide surface 230 at the node 232 defines an apex 238 of the plug 216. The radial extension of the flow guide surface 230 from the node 232 to the perimeter surface 218, in conjunction with the concave curvature of the first portion 234 and the convex curvature of the second portion 236, produces a bell-shaped configuration of the flow guide surface 230. The flow guide surface 230 may further include a transition portion 239, as shown in FIGS. 2-4. The transition portion 239 is disposed between the first portion 234 and the perimeter surface 218 and has a convex curvature. The convex curvature of the transition portion 239 provides a smooth transition from the perimeter surface 218 to the first portion 234 of the flow guide surface 230.

As shown in FIGS. 2 and 3, the flow guide surface 230 extends into the outlet corridor 206 in both the open position and the closed position. The concave curvature of the first portion 234 of the flow guide surface 230 and the convex curvature of the second portion 236 of the flow guide surface 230 spaces the flow guide surface 230 from the outlet surface 228 in both the open position and the closed position. Furthermore, the concave curvature of the first portion 234 and the convex curvature of the second portion 236 presents a pathway 240 between the plug 216 and the seat 208/the body 102 when the plug 216 is in the open position.

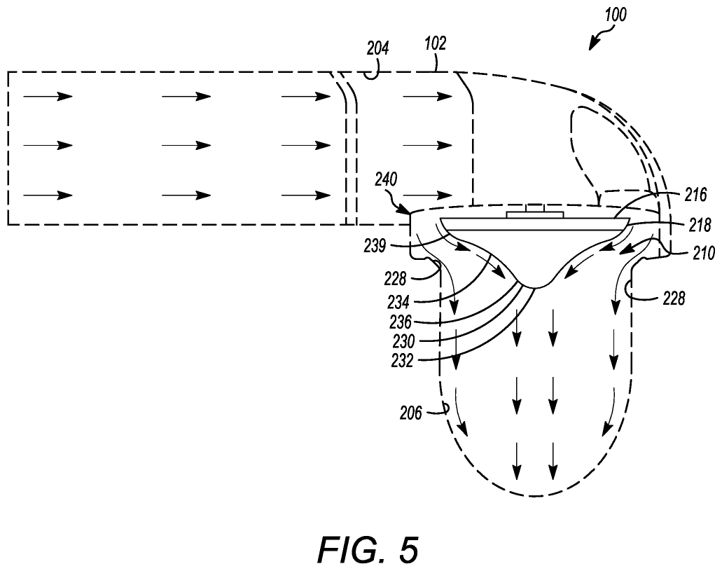

FIG. 5 is a schematic side view illustration of the linear displacement valve 100 of FIG. 2, showing the flow of the fluid through the linear displacement valve 100. With reference to FIG. 5, the convex curvature of the transition portion 239 provides a smooth radius that is positioned within the inlet corridor 204 when the plug 216 is in the open position. The smooth radius of the convex curvature of the transition portion 239 allows directing the fluid there along, streamlining the flow of the fluid from the inlet corridor 204 through the opening 210 and reducing fluid separation along the plug 216. The concave curvature of the first portion 234 compensates the contraction of the flow-cross-sectional area from the inlet corridor 204 to the pathway 240 between the plug 216 and the seat 208, making the flow transition smoothly. Furthermore, the concave curvature of the first portion 234 guides the bulk fluid flowing across the flow guide surface 230 toward the second portion 236 and the node 232 having the apex 238. As such, the fluid moving along the flow guide surface 230 (which radially surrounds the node 232) converges at the node 232 and separates from the flow guide surface 230 with substantially reduced wake that transmits longitudinally through the outlet corridor 206.

It is to be appreciated that the flow guide surface 230 may be any suitable configuration for producing substantially streamlined flow of the fluid from the inlet corridor 204 to the outlet corridor 206. The shape and size of the flow guide surface 230, the location of the node 232, the curvature of the flow guide surface 230, etc. may be adjusted to maximize the cross-sectional area of the flow of the fluid through the linear displacement valve 100. More specifically, variations in attributes of the linear displacement valve 100 that are shown in the Figures may produce flow characteristics that are different than the flow characteristics described above and shown in the Figures. For example, variations in the cross-sectional areas of the inlet corridor 204 and the outlet corridor 206, variations in the shape of the inlet corridor 204 and the outlet corridor 206, variations in the angle at which the inlet corridor 204 and the outlet corridor 206 are disposed, shape of the opening 210, the cross-sectional area of the opening 210, etc., can require different attributes to the plug 216 in comparison to the plug 216 shown in the Figures and described above. Attributes of the flow guide surface 230 that may vary include, but are not limited to, the shape of the perimeter surface 218, the curvature of the transition portion 239, the first portion 234, and/or the second portion 236 of the flow guide surface 230, the height H and/or the width W of the plug 216, and the location of the node 232 relative to the perimeter surface 218.

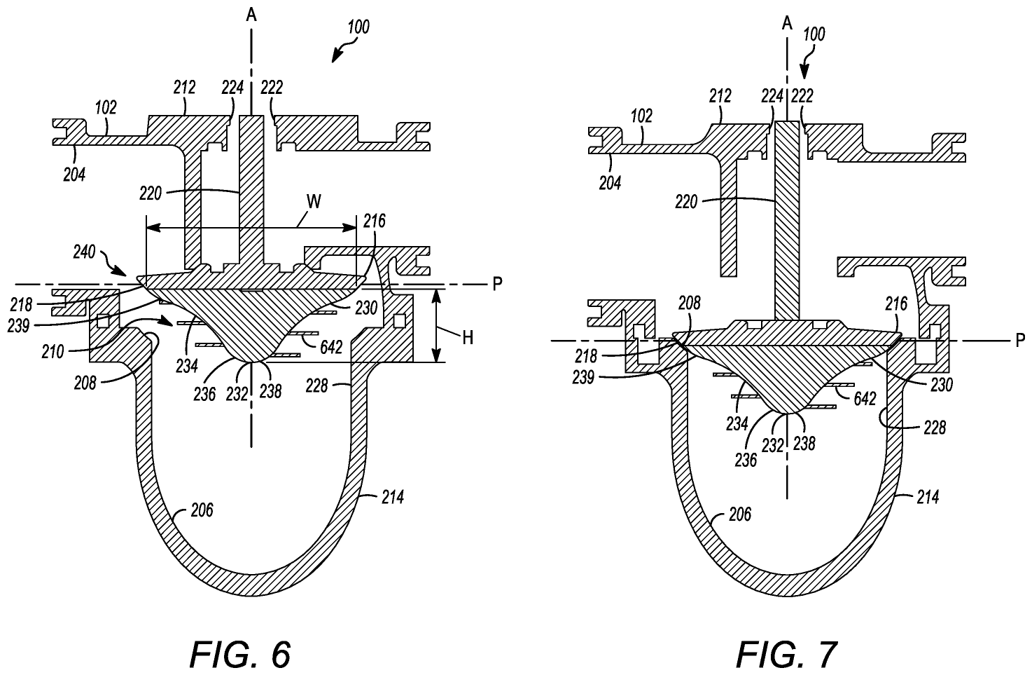

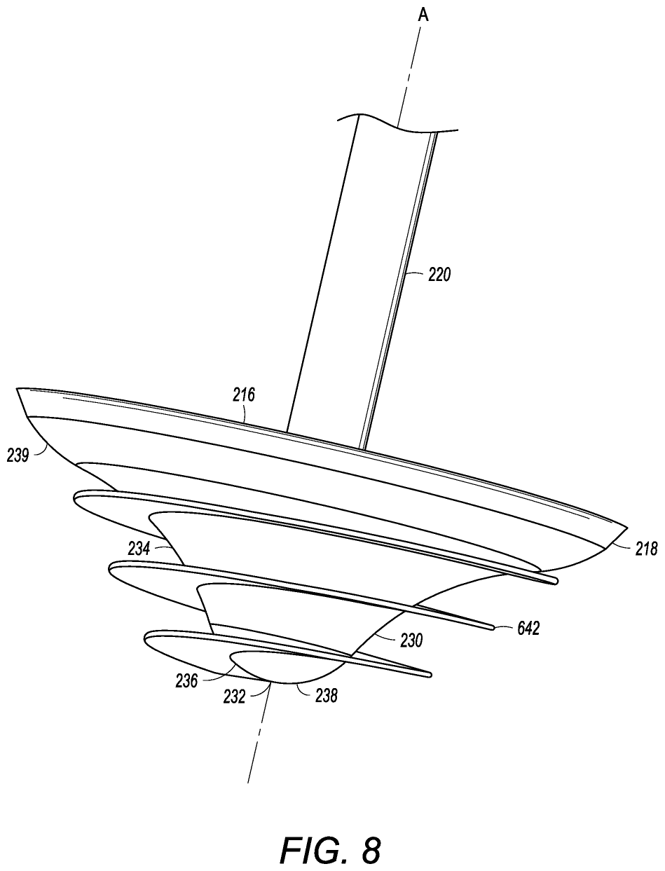

FIGS. 6-9 show an example implementation of the linear displacement valve 100 in which the linear displacement valve 100 further includes a fin 642 disposed along and extending from the flow guide surface 230 in a helical configuration between the perimeter surface 218 and the node 232. The fin 642 directs the flow of the fluid along the flow guide surface 230 from the perimeter surface 218 to the node 232. As shown in FIG. 8, the fin 642 extends in a clockwise orientation along the flow guide surface 230 between the perimeter surface 218 and the node 232. However, the fin 642 may extend in a counter-clockwise orientation along the flow guide surface 230 between the perimeter surface 218 and the node 232.

As shown in FIGS. 6 and 7, the fin 642 extends outwardly from the flow guide surface 230 in a direction generally parallel to the plane P. Moreover, the fin 642 extends outwardly from the flow guide surface 230 in a direction generally orthogonal to the axis A. More specifically, although the helical configuration of the fin 642 angles the fin 642 to extend between the perimeter surface 218 and the node 232, the cross-sectional profile of the fin 642 extending radially from the axis A is in a direction generally parallel to the plane P and the generally orthogonal to the axis A. In one example, the term “generally parallel to the plane P” refers to less than or equal to 10 degrees from parallel to the plane P in either direction along the axis A. In another example, the term “generally parallel to the plane P” refers to less than or equal to 5 degrees from parallel to the plane P in either direction along the axis A.

In the example shown in FIGS. 6-8, the fin 642 has a substantially flat and uniform configuration. However, the fin 642 may extend from the flow guide surface 230 in any suitable shape and configuration.

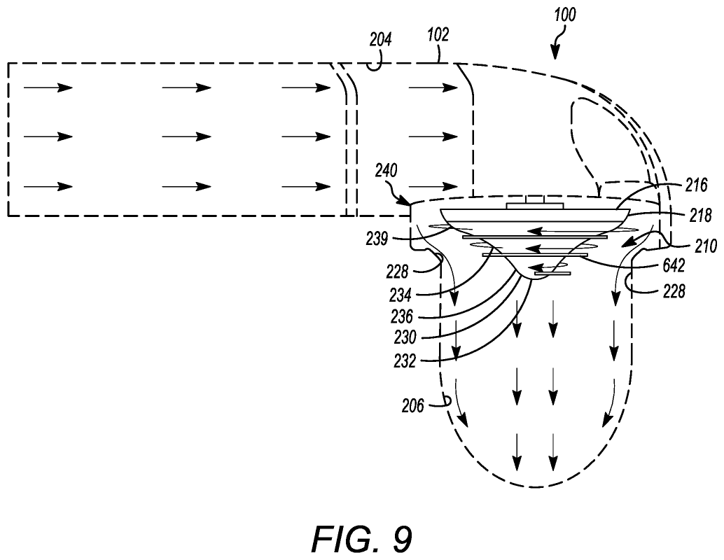

Similar to the example shown in FIGS. 2-5 and described above, the flow guide surface 230 of FIGS. 6-9 extends into the outlet corridor 206 in both the open position and the closed position. FIG. 9 is a schematic side view illustration of the linear displacement valve 100 of FIG. 6, showing the flow of the fluid through the linear displacement valve 100. With reference to FIG. 9, the concave curvature of the first portion 234 of the flow guide surface 230 and the convex curvature of the second portion 236 of the flow guide surface 230 spaces the flow guide surface 230 from the outlet surface 228 in both the open position and the closed position. Furthermore, the concave curvature of the first portion 234 and the convex curvature of the second portion 236 presents the pathway 240 between the plug 216 and the seat 208/the body 102 when the plug 216 is in the open position. The convex curvature of the transition portion 239 provides a smooth radius that is positioned within the inlet corridor 204 when the plug 216 is in the open position. The smooth radius of the convex curvature of the transition portion 239 allows directing the fluid there along, streamlining the flow of the fluid from the inlet corridor 204 through the opening 210 and reducing fluid separation along the plug 216. The concave curvature of the first portion 234 compensates the contraction of the flow-cross-sectional area from the inlet corridor 204 to the pathway 240 between the plug 216 and the seat 208, making the flow transition smoothly. Furthermore, the concave curvature of the first portion 234 guides the bulk fluid flowing across the flow guide surface 230 toward the second portion 236 and the node 232 having the apex 238.

The fluid passes along the concave surface and engages the fin 642. The helical configuration of the fin 642 redirects flow of the fluid radially around the plug 216, with gradual progression toward the node 232, producing rotational flow of the fluid that forms a vortex around the plug 216. The convex curvature of the second portion 236 guides the fluid adjacent to the fin 642 flowing across the flow guide surface 230 toward the node 232 having the apex 238, at which point the fluid detaches from the flow guide surface 230 with substantially reduced wake that transmits longitudinally through the outlet corridor 206.

The plug 216 described in the examples above may formed of any suitable material to allow movement of the plug 216 between the open position and the closed position, allow flow of the fluid across the flow guide surface 230, and allow the plug 216 to seal against the seat 208. The material of the plug 216 may comprise a metal, a metal alloy, a polymer, a ceramic, etc. Moreover, the plug 216 may be more than one of the materials, with the materials varying in composition.

The words “example” or “implementation” are used herein to illustrate an example, instance, or illustration, and are not necessarily to be construed as preferred or advantageous over other aspects or designs. The term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

While implementations have been illustrated and described, it will be appreciated that various changes can be made therein without departing from the spirit and scope of the disclosure. Moreover, the various features of the implementations described herein are not mutually exclusive. Rather any feature of any implementation described herein may be incorporated into any other suitable implementation. If the concept and technical scheme of the disclosure are directly applied to other occasions, they all fall within the protection scope of the present disclosure.

What is claimed is:

1. A linear displacement valve for a vehicle, the linear displacement valve comprising:
a body defining an inlet corridor and an outlet corridor;
a seat disposed within the body between the inlet corridor and the outlet corridor, with the seat defining an opening configured to fluidly couple the inlet corridor with the outlet corridor; and
a plug movable relative to the seat, the plug comprising:
a perimeter surface configured to abut and seal against the seat to close the opening; and
a flow guide surface having a first portion and a second portion, with the first portion of the flow guide surface disposed between the second portion of the flow guide surface and the perimeter surface,
wherein the first portion has a concave curvature, and the second portion has a convex curvature.

2. The linear displacement valve of claim 1, wherein the perimeter surface and the seat have annular configurations that correspond to one another.

3. The linear displacement valve of claim 1, wherein the plug includes a node spaced from and surrounded by the perimeter surface, with the flow guide surface arranged to extend radially from the node to the perimeter surface.

4. The linear displacement valve of claim 3, wherein the second portion of the flow guide surface is configured to converge at the node and defines an apex of the plug.

5. The linear displacement valve of claim 3, wherein the perimeter surface has an annular configuration, with the node centrally aligned within the perimeter surface.

6. The linear displacement valve of claim 3, wherein the perimeter surface of the plug has a width between opposing portions of the perimeter surface and has a height to the node, orthogonal to the width, with the plug having a width-to-height ratio of about 4/1 to about 2/1.

7. The linear displacement valve of claim 3, further comprising a fin extending from the flow guide surface in a helical configuration between the perimeter surface and the node.

8. The linear displacement valve of claim 1, wherein the perimeter surface is disposed on a plane, with the seat extending transverse to the plane.

9. The linear displacement valve of claim 8, wherein the plug is movable along an axis that is orthogonal to the plane.

10. The linear displacement valve of claim 9, further including a stem mounted to the plug and a guide coupled to the body and the defining a bore, with stem slidably disposed within the bore such that the guide is configured to retain movement of the stem and the plug along the axis.

11. The linear displacement valve of claim 9, wherein the body includes an outlet surface extending from the seat and at least partially defining the outlet corridor, with the outlet surface extending in a direction generally parallel to the axis.

12. A plug for use with a linear displacement valve, the plug comprising:
a perimeter surface configured to abut and seal against a seat to close an opening; and
a flow guide surface having a first portion and a second portion, with the first portion of the flow guide surface disposed between the second portion of the flow guide surface and the perimeter surface,
wherein the first portion has a concave curvature, and the second portion has a convex curvature.

13. The plug of claim 12, further comprising a node spaced from and surrounded by the perimeter surface, with the flow guide surface arranged to extend radially from the node to the perimeter surface.

14. The plug of claim 13, wherein the second portion of the flow guide surface is configured to converge at the node and defines an apex of the plug.

15. The plug of claim 13, wherein the perimeter surface has an annular configuration, with the node centrally aligned within the perimeter surface.

16. The plug of claim 13, wherein the perimeter surface of the plug has a width between opposing portions of the perimeter surface and has a height to the node, orthogonal to the width, with the plug having a width-to-height ratio of about 4/1 to about 2/1.

17. The plug of claim 13, further comprising a fin extending from the flow guide surface in a helical configuration between the perimeter surface and the node.

18. The plug of claim 17, wherein the perimeter surface is disposed on a plane, with the fin extending outwardly from the flow guide surface in a direction generally parallel to the plane.

19. The plug of claim 12, wherein the flow guide surface further includes a transition portion disposed between the first portion and the perimeter surface, with the transition portion having a convex curvature.

20. A linear displacement valve for a vehicle, the linear displacement valve comprising:
a body defining an inlet corridor and an outlet corridor;
a seat disposed within the body between the inlet corridor and the outlet corridor, with the seat defining an opening configured to fluidly couple the inlet corridor with the outlet corridor; and
a plug movable relative to the seat, the plug comprising:
a perimeter surface configured to abut and seal against the seat to close the opening;
a node spaced from and surrounded by the perimeter surface;
a flow guide surface having an arcuate configuration between the perimeter surface and the node; and
a fin disposed along the flow guide surface and extending in a helical configuration between the perimeter surface and the node.

21. The linear displacement valve of claim 20, wherein the perimeter surface is disposed on a plane, with the fin extending outwardly from the flow guide surface in a direction generally parallel to the plane.
